(19) United States
(12) Patent Application Publication
(10) Pub. No.: US 2008/0195736 A1
(43) Pub. Date: Aug. 14, 2008

(54) Wireless Network Connection Supporting Apparatus, Connection Supporting System, Connection Supporting Method and Program Using Same

(75) Inventor: Kayato Sekiya, Tokyo (JP)

Correspondence Address: FOLEY AND LARDNER LLP;SUITE 500, 3000 K STREET NW, WASHINGTON, DC, 20007, US

(73) Assignee: NEC Corporation, Tokyo (JP)

(21) Appl. No.: 11/886,305

(22) PCT Filed: Mar. 13, 2006
(86) PCT No.: PCT/JP2006/304912

§ 371 Date: Sep. 14, 2007

(30) Foreign Application Priority Data
Mar. 16, 2005 (JP) 2005-074192

(51) Int. Cl. G06F 15/16; H04L 9/06

(52) U.S. Cl. 709/227; 380/270

(57) ABSTRACT

A wireless network connection supporting apparatus, a supporting system using the same, a method therefor and a program wherein a wireless LAN to be supported is connected by trial to enable the decoding of an encrypted packet and also enables a confirmation of the operation of the main system of a backend, thereby a connection support for a wider range of causes of troubles can be achieved. A wireless network connection supporting apparatus (100) supports a connection of a wireless communication terminal (30) to a wireless network (10). During a normal operation of the wireless network (10), the wireless network connection supporting apparatus (100) uses a test account, which can provide a correct connection, to perform a connection trial to the wireless network (10), analyzes a trail result of the connection trail, and outputs an operational instruction corresponding to the analysis result.

### TECHNICAL FIELD

The present invention relates to a wireless network connection supporting apparatus, a connection supporting system, connection supporting method and programs using the same and more particularly to the method for supporting the connection to wireless networks to provide support for connecting operations according to results of trials of connections to wireless networks and analysis of wireless packets.

### BACKGROUND TECHNOLOGY

In the connection to a wireless network such as a wireless local area network (wireless LAN), since setting for the connection is complicated and contents of the setting are different for every network, once a failure occurs in the connection, it is difficult to specify which part of the setting is to be corrected. Due to this, there are many cases in which support is needed by a user trying to establish connections to a wireless network, however, in a public wireless LAN or a like, an infrastructure to provide connection service and an infrastructure (for example, hotel or a like) being resident in a place where a wireless network is placed are different from each other and, therefore, it is difficult to provide sufficient connection support to the user in such a local area in many cases.

In the situation as described above, remote support service by using a telephone or a like is available, however, in such a case, oral explanation of a local condition by the user is required and, as a result, even in the case of a simple mistake of setting, a certain period of time is necessary to solve the problem, which causes high support costs. Therefore, the advent of a method combined with another low-cost connection support method is desired and expected.

As a conventional technology being able to provide such support, Airopeek NX being wireless LAN protocol analysis software from Wild Packets is available (see Non-patent Reference No. 1). A device installing software using the conventional technology is so configured as to passively receive (intercept) packets incommunication media, to analyze contents, according to the IEEE (Institute of Electrical and Electronics Engineers) 802.11 standards, to display the result from the analysis on a screen and/or to output an advise message. Thus, by providing such a device together with a wireless network, a user can get advice on a connection fault by referring to information displayed on the screen of the device.

Non-patent Reference 1: Airopeek NX Product Datasheet (Second paragraph; APNX-1.2-20040803, Section; [Expert Analysis]) (http://www.wildpackets.com).

### DISCLOSURE OF THE INVENTION

### PROBLEMS TO BE SOLVED BY THE INVENTION

However, the conventional wireless network connection support method has a problem in that connection support with consideration given to causes for failures occurring outside a wireless network layer is impossible. More specifically, the first problem is that, in a wireless network in which packets are encrypted such as a wireless LAN using the IEEE802.IX authentication method, it is impossible to provide advise according to results from analysis of packets in a layer above an IP (Internet Protocol) layer.

This is because, in the wireless LAN using the IEEE802.1X authentication method, data (DATA) packets to be used for transfer of packets in the layer above the IP layer are encrypted and, as a result, a decryption key to decrypt the data packets cannot be obtained by using the method by which packets are passively received, making it impossible to analyze the contents of the above data.

The second problem is that it is also impossible for the conventional connection support method to distinguish a connection fault caused by a malfunction of the main system of a backend of a wireless LAN from a connection fault caused by a mistake in setting for a user device. For example, when a malfunction occurs in a line connecting an authentication server used to authenticate user connections to a wireless LAN with a directory server used to store registered information of the user, if a packet is received by the conventional technology, a state is observed in which a reply to the authentication packet transmitted by a user device is not returned, whereas the same state is observed even if a user sets a wrong user name and/or wrong password and, as a result, the distinction between the two states cannot be made by the conventional technology used therein.

In the view of the above problems, an object of the present invention is to provide a wireless network connection support device and connection support system using the wireless network connection supporting apparatus, and a method and program of providing the connection support using the same which are capable of providing the connection support with causes for troubles occurring outside a wireless network layer being also taken into account and of achieving the connection support against a wider range of causes for troubles by executing trial connections to a wireless LAN to which support is to be provided to decrypt an encrypted packet and to check and confirm operations of a basic system existing in a back-end system.

### MEANS FOR SOLVING PROBLEMS

The connection supporting apparatus of the present invention is characterized in that it is a wireless network connection supporting apparatus to provide a wireless communication terminal with connection service and in that it includes a connection trying means to execute a connection trial to a wireless network by using a test account that can provide a correct connection while a wireless network is operating normally, an analyzing means to analyze a trial result from a connection trial, an outputting means to provide an operational instruction corresponding to the analysis result obtained by the analyzing means, and further a communicating means to transmit, via a network, the analysis result to a device placed far physically.

The connection supporting system of the present invention also includes at least one connection supporting apparatus described above and a trouble example database to be referred to by the analyzing means of the connection supporting apparatus and to store analysis results and solving operations.

The connection supporting method of the present invention is characterized in that it is a wireless network connection supporting method to provide a wireless communication terminal with connection service and includes a connection trying step of executing a connection trial to a wireless network by using a test account that can provide a correct connection during a time of normal operations of a wireless network, an analyzing step of analyzing trial results from a connection trial, an outputting step of providing an operational instruction corresponding to analysis results obtained in the analyzing step.

The program of the present invention is characterized in that it is program to make a computer to execute operations of the wireless network connection supporting method to provide a wireless communication device with support for connections to a wireless network and in that it includes a connection trying processing of executing a connection trial to a wireless network by using a test account that can provide a correct connection during a time of normal operations of a wireless network, an analyzing processing of analyzing trial results from a connection trial, an outputting processing of providing an operational instruction corresponding to analysis results obtained in the analyzing processing.

Next, operations of the present invention are described. Connection trials to a wireless network are executed by the connection trying part by using a test account that can provide a correct connection during a time of normal operations of the wireless network and an operational state of the wireless network is analyzed and checked and all packets being able to be received from a wireless medium are received by the wireless interface part by obtaining an encryption key at the same time and, if received packets are encrypted, decrypting processing is performed by using a decryption key and an operational instruction is output to the output part according to analysis results obtained by the analyzing part. This enables connection support without adding any change to a user device to be supported according to analysis results of packets existing in a layer above a wireless layer and also enables connection support with a connection trouble caused by a malfunction of a wireless network system and a connection trouble caused by a mistake in setting of a user device being distinguished from each other.

### EFFECTS OF THE INVENTION

The first effect of the present invention is that it is made possible to distinguish a connection trouble caused by a malfunction on a wireless network side from a connection trouble caused by a mistake in setting of a user device. This is owing to the configuration in which a connection trial to a wireless network is executed by using a test account that can provide a correct connection while a wireless network is operating normally and it is judged that, if the connection trial results in a failure, causes for the failure in the connection exists on the wireless network side.

The second effect of the present invention is that, in a wireless network in which packets are encrypted such as a wireless LAN using the IEEE802. 1X authentication method, it is made possible to provide connection support based on analysis results of encrypted broadcast packets, more particularly, based on analysis results of packets in an IP layer. This is owing to the configuration in which the connection trying part acquires a broadcast key at the time of connection trials.

### BRIEF DESCRIPTION OF DRAWINGS

FIG. 1 is a block diagram showing rough configurations of a connection supporting system and components making up the connection supporting system according to the first embodiment of the present invention.

FIG. 2 is a block diagram showing a representative configuration of a wireless network to which connection support is provided.

FIG. 3 is a flowchart showing operations in the first embodiment of the present invention.

FIG. 4 is a timing chart explaining transmission and receiving of packets at the time of connection between a user device and a wireless network.

FIG. 5 shows one example of a correspondence table showing analysis results and solving operations to be referred to by an analyzing part of the connection supporting apparatus of the first embodiment of the present invention.

FIG. 6 is one example of operational instructions being output on a screen by an output part of the connection supporting apparatus of the first embodiment of the present invention.

FIG. 7 is a block diagram showing rough configurations of a connection support system and components of a connection support apparatus used in the connection support system according to a second embodiment of the present invention.

FIG. 8 is a flowchart showing one example of operations of a user device to be supported in the connection supporting apparatus according to the second embodiment of the present invention.

FIG. 9 is a diagram showing one example of a screen output from an output part when an input part receives an input from user.

FIG. 10 is a graph showing relation among wireless packets to be analyzed when a user to be supported is specified, time of user input, and receiving power of the wireless packets in the connection supporting apparatus according to the second embodiment of the present invention.

FIG. 11 is a block diagram showing rough configurations of a connection support system and components of a connection support apparatus used in the connection support system according to a third embodiment of the present invention.

FIG. 12 is a flowchart showing an example of operations of estimating an access point to which a user device tries to establish a connection in the connection supporting apparatus according to the third embodiment of the present invention.

FIG. 13 is a block diagram showing rough configurations of a connection support system and components of a connection support apparatus used in the connection support system according to a fourth embodiment of the present invention.

FIG. 14 is a block diagram showing main components of the first connection supporting system of the present invention.

FIG. 15 is a block diagram showing rough configurations of a connection supporting system and components of a connection supporting apparatus used in the connection supporting system according to a fifth embodiment of the present invention.

FIG. 16 is a block diagram showing main components of the second connection supporting system of the present invention.

FIG. 17 is a block diagram showing main components of the third connection supporting system of the present invention.

FIG. 18 is an example of a screen containing an identifier output by the output part.

FIG. 19 is a flowchart showing one example of a method of displaying an obtained identifier in the connection supporting method of the present invention.

FIG. 20 is a flowchart showing one example showing a method of issuing an identifier and displaying received analysis results on a screen of a user support center side device.

### EXPLANATION OF LETTERS OR NUMERALS

10: Wireless network, 20: Connection trying part, 30: User device, 40: Wireless interface part, 50: Storing par, 60: Decoding part, 70: Analyzing part, 71: Support object judging part, 72: Access point selecting part, 73: Communicating part, 80: Output part, 90: Trouble example database, 91: Local information receiving part, 92: Local information outputting part, 93: Automatic terminating part, 94: Speech part, 100: Connection supporting apparatus, 200: User support center side device

### BEST MODE FOR CARRYING OUT THE INVENTION

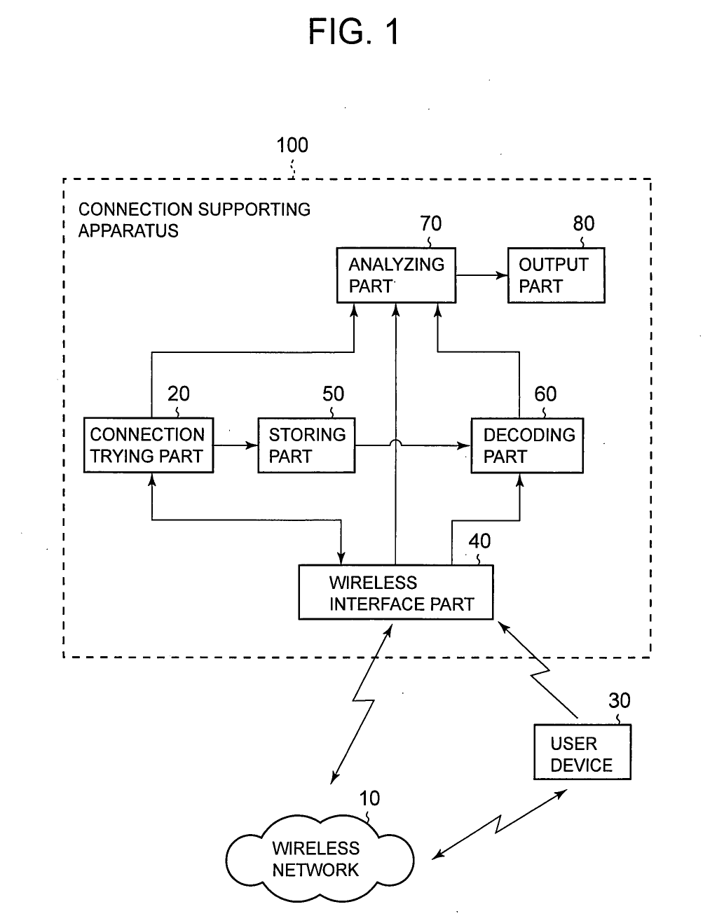

Hereinafter, some preferred embodiments of the present invention are described in detail by referring to attached drawings. FIG. 1 is a block diagram showing rough configurations of a connection supporting system and components making up the connection supporting system according to the first embodiment of the present invention. As shown in FIG. 1, the connection supporting system of the present invention includes a connection supporting apparatus 100, a wireless network 10, and a user device 30 serving as a wireless communication terminal.

The connection supporting apparatus 100 of the first embodiment includes a connection trying part 20 to execute a trial connection to the wireless network 10 by using a test account that can provide a correct connection during a time of normal operations of the wireless network 10, a wireless interface part 40 to transmit and receive packets to and from the wireless network 10 and user device 30, a storing part 50 to store a key which the connection supporting part 20 receives when succeeding in the connection trial, a decoding part 50 to decode packets using the key stored in the storing part 50 when packets to be received are encrypted, an analyzing part 70 to analyze packets and results from trial connections executed by the connection trying part 20, and an output part 80 to output solving operational instructions corresponding to the analysis result.

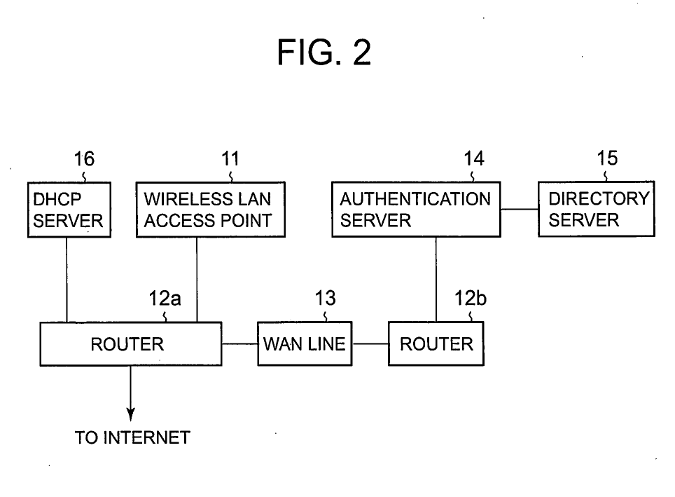

The wireless network 10, as shown in FIG. 2, is typically made up of a wireless LAN access point 11, routers 12a and 12b, a wide area network (WAN) line 13, an authentication server 14, a directory server 15, and a dynamic host configuration protocol (DHCP) server 16.

The access point 11, when receiving a connection request containing user registered information such as a user name, password, or a like from a wireless device, transmits an authentication request to the authentication server 14 via the router 12a. Here, the wireless device includes the user device 30 and connection supporting apparatus 100. The authentication server 14, when receiving an authentication request, makes an inquiry of the directory server 15 storing user registered information (account) and judges whether authentication has succeeded or failed. When the authentication has succeeded, the authentication server 14 makes a response including information about the success or failure to the access point 11. The access point 11 permits packets to be transmitted or received by the wireless devices to pass through the access point. Consecutively, the wireless device obtains an IP address from the DHCP server 16 and accesses to the Internet.

The connection trying part executes trial connections to the wireless network 10 by using a test account. The test account is an account already registered with the directory server 15 and already confirmed as being correctly connected while the wireless network 10 operates normally. Here, the “being correctly connected” refers to a state in which the authentication succeeds and an IP address is obtained from the DHCP server and an access to the Internet is enabled.

Moreover, the “normal operation of a wireless network” represents a state in which each component of the wireless network 10 is operating as intended, whereas the abnormal operation of the wireless network represents a state in which a problem exists in an operation of any one of components. An example of the abnormal operation is a state in which connections between the authentication server 14 and directory server 15 are broken. In this state, even if a connection trial is executed by using an test account, the directory server 15 is unable to make a response to an inquiry from the authentication server and, as a result, a failure occurs in authentication. The connection trying part 20, when failing in connections using the test account, judges that causes for the failure in connections exist on the wireless network 10 side.

While the wireless network 10 is operating normally, if the connection trying part 20 succeeds in the trial connections, the connection trying part 20 ordinarily receives two kinds of key from the wireless LAN access point 11. One is a unicast key and the other is a broadcast key. The unicast key is a key used for encryption of a unicast (a destination of a packet is a single wireless device) data packets and a specific key is assigned to every wireless key having succeeded in authentication. The broadcast key is a key used for encryption of broadcast data packets (in the case of the wireless LAN, a destination of a packet is all wireless devices being under control of an access point) and a common key can be used in all wireless devices being under control of the access point.

Here, the data packet refers to a packet which has a frame type of “DATA” designated, for example, in the IEEE802.11 standards. As an encryption and decryption method, for example, a WEP (Wired Equipment Privacy) encryption method based on an RC4 private key encryption method is used. A key used in the WEP encryption method is called a “WEP key”. The broadcast key out of these two WEP keys in particular is stored in the storing part 50. Moreover, there is a wireless network in which an encryption key is periodically renewed, however, in this embodiment, the key for the storing part 50 is replaced with a renewed key.

The user device 30 is an object device to which the connection supporting apparatus 100 provides connection support. An example of the user device 30 includes, for example, a personal computer (PC) having a wireless LAN card to be employed by a user having signed a contract to be provided with a network connection service to be offered by the wireless network 10. The connection supporting apparatus 100 outputs a solving operational instruction for a user to the output part 80 so as to support the user so that a correct connection is established between the user device 30 and the wireless network 10.

The wireless interface part 40 has a function of transmitting wireless packets to the wireless network 10 and receiving all wireless packets that can be received from the wireless network 10 and the user device 30. An example of the wireless packet includes a wireless LAN frame designated by the IEEE802.11 standards. Moreover, the state “can be received” denotes a state in which a head and tail of a packet can be identified and read as a unit that can be processed in a physical layer of the wireless network 10.

Ordinarily, an error detection using a CRC (Cyclic Redundancy Check) method or a like is performed on the packet read as the unit that can be processed and packets from which an error is detected are abandoned, however, alternatively, the packets from which errors are detected may be analyzed by the analyzing part 70. Ordinarily, a packet from which no error is detected is selectively received or abandoned depending on its destination address. The term of “receiving all packets” described above means that receivable packets are not abandoned irrespective of their destination addresses.

However, there is possibly a case in which it is made impossible to transmit wireless packets if the wireless interface part 40 performs operations of receiving all receivable wireless packets. In this case, the wireless interface part 40 switches between an operation mode (connection mode) in which transmission of wireless packets is enabled and an operation mode (wireless monitoring mode) in which receiving of all receivable wireless packets is enabled. Moreover, in the wireless network in which a key is periodically renewed, a case occurs in which an ACK (Acknowledgement) has to be transmitted to a key to be renewed and, in such a case, the operation mode is switched from the wireless monitoring mode to the connection mode and, after the transmission of the ACK, the mode is switched from the connection mode to the wireless monitoring mode.

The decoding part 60 decrypts encrypted broadcast packets in particular, out of encrypted packets received by the wireless interface part 40 by using a key stored in the storing part 50 and transfers the decoded packets to the analyzing part 70. The analyzing part 70 analyzes results from connection trials performed by the connection trying part 100, packets not encrypted, decrypted packets out of encrypted packets, packets not yet decrypted out of encrypted packets, part of packets and/or all packets from which an error is detected by an error detection method including the CRC method and judges which solving operation is to be performed to solve the above situation. Moreover, history data of results from analyses of past packets may be used for the above analysis by the analyzing part 70.

The output part 80 is equipped with a screen on which, for example, solving operations, in the form of solving operational instructions to a user, are graphically displayed and has a function of displaying solving operational instructions judged by the analyzing part 70 as necessary operations on the screen, however, it is clear that a voice message of the solving operational instructions may be used instead of the displaying on the screen.

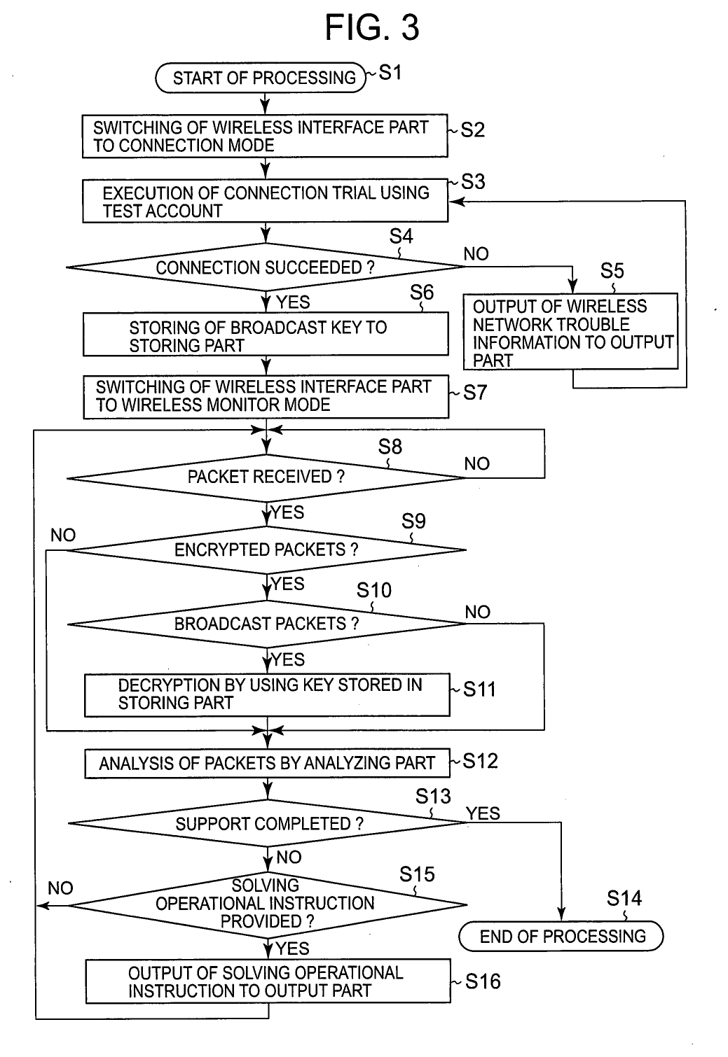

Next, operations in the first embodiment are described in detail by referring to the flowchart shown in FIG. 3. Processing is started in Step S1. The timing with which processing is started is considered to be related to both of two factors, one is an external factor such as a touch of a user on a displaying portion of the output part 80 and another is an internal factor such as a periodical operation start by an internal timer embedded in the connection trying part 20. In Step S2, an operation mode of the wireless interface part 40 is switched to the connection mode and wireless packets get into a transmissible state. Then, in Step S3, the connection trying part 20 executes trial connections, by using a test account, to the wireless network 10 via the wireless interface part 40. At this point of time, the trial connections results in a success if the wireless network 10 is in a normal operational state and results in a fail if the wireless network 10 in an abnormal state.

In Step S4, according to judgments of results of the trials, the connection trying part 20, if the connection trial results in a failure, outputs a message that a failure has occurred in the wireless network 10 to the output part via the analyzing part 70 (Step S5). When the connection results in a success (Step S6), the connection trying part 20 receives a broadcast key from the access point 11 and stores it to the storing part 50. Then, the wireless interface part 40 is switched to the wireless monitor mode and a state appears that all the receivable packets are received. In Step S8, an arrival of a wireless packet is waited for and, when the wireless packet is received, a judgment is made as to whether the received packets are encrypted or not or are broadcast packets or not (Step S9 and S10).

When received packets are encrypted broadcast packets, the packets are decrypted by using a broadcast key stored in the storing part 50 (Step S11). The received packets are then analyzed by the analyzing part 70 (Step S12). When it is confirmed by this analysis that the user device 30 is correctly connected to the wireless network 10 (Step S13) and support is completed, the processing ends (Step S14).

On the other hand, if, as the result of the analysis, no correct connection is detected, the routine proceeds to Step S15 and a judgment is made as to whether the corresponding solving operational instruction is provided or not. At this time point, if there is a solving operational instruction to be output to the output part 80, the routine proceeds to Step S16 and a solving operational instruction is output to the output part 80. If the analysis of much more packets is required to provide proper solving operational instructions, the routine is returned back to Step S28 without outputting the solving operational instructions to the output part 80 and an arrival of packets is waited for. The above processes are repeated until support is completed.

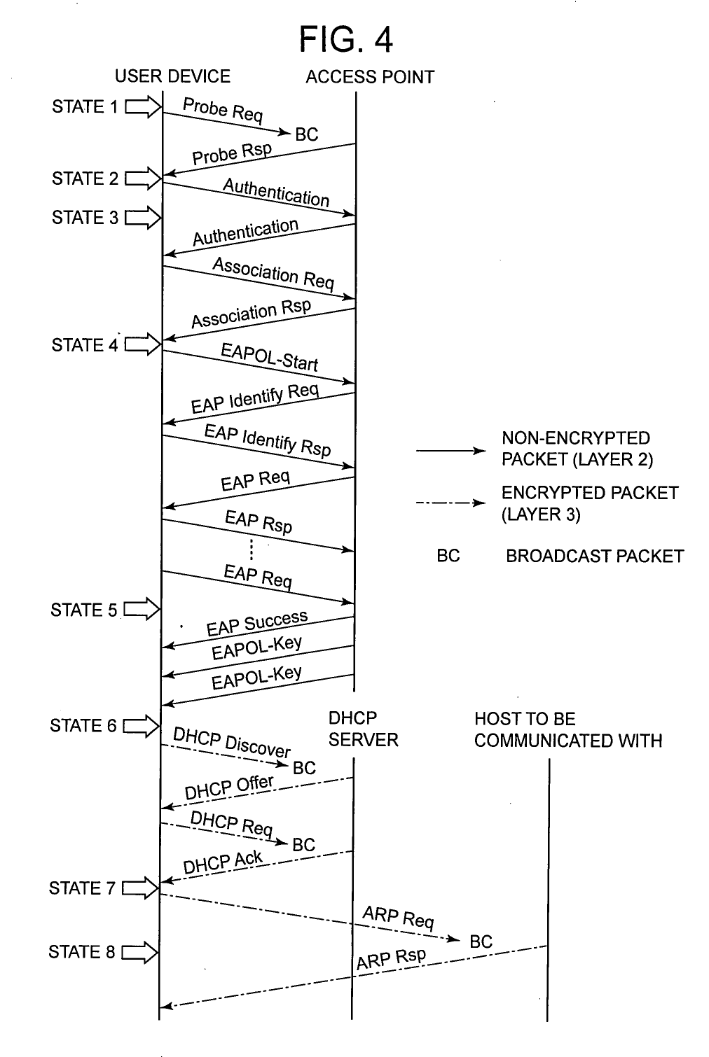

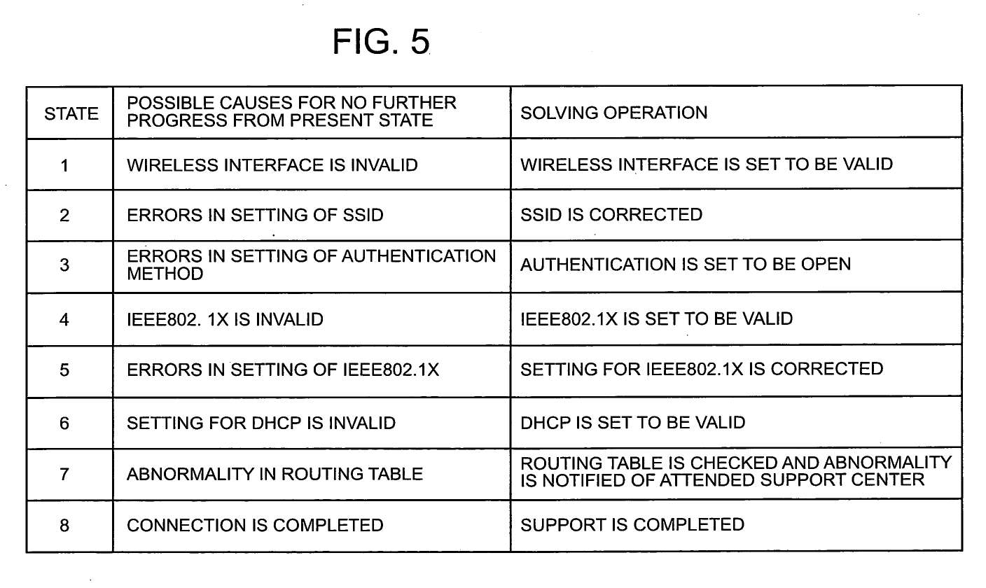

Then, the method by which the analyzing part 70 analyzes packets to be input and determines solving operational instructions is described by referring to FIGS. 4 and 5. FIG. 4 displays flows of packets to be transmitted and received at the time of connection to a representative wireless network which operates according to the IEEE802.11 and uses the IEEE802.1X authentication method and the flows of packets are designated by the IEEE802.11 and 802.1X standards and their descriptions are omitted accordingly.

The correct connection of the user device 30 is completed when a state starts from the state 1 and reaches the state 8. On the other hand, if the state progress stops halfway and no progress occurs, there may be some connection troubles. FIG. 5 shows a list of possible causes for troubles when no further progress occurs in each state of states 1 to 7. The analyzing part 70 keeps track of the progress state of the user device 30 based on packets to be input from the wireless interface part 40 and the decoding part 60. If no progress occurs in a specific state and thereafter, a solving operational instruction to solve the troubled state is output to the output part 80.

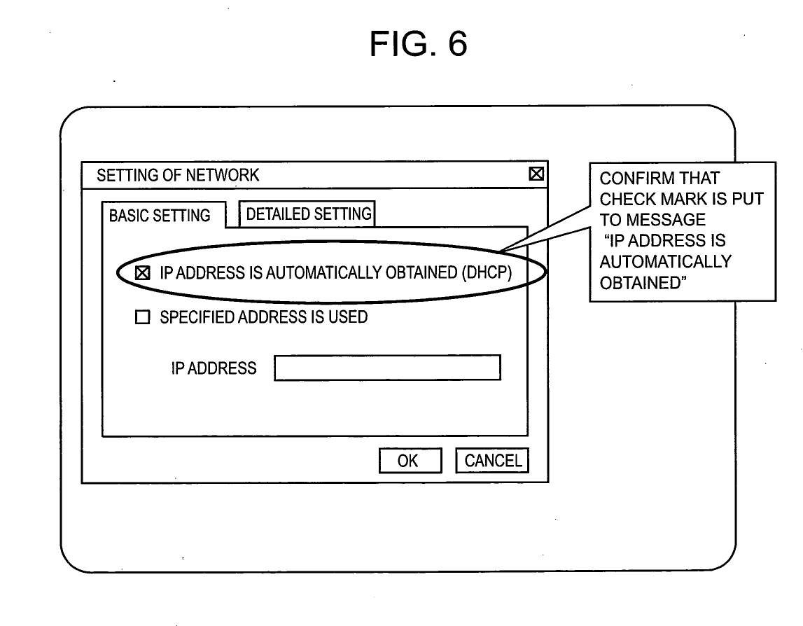

For example, if no progress occurs in the state 6 and thereafter in the user device 30, it is judged that a mistake in setting of the DHCP has occurred and the solving operational instruction shown in FIG. 6 is output to the output part 80. That is, in this case, since the setting for the DHCP is invalid, as an example of operations to solve the problem, a message of “IP address is automatically obtained (DHCP)” is output.

Thus, by applying the present invention, it is made possible to provide connection support based on analysis results of encrypted broadcast packets and more specifically based on analysis results of packets in the IP layer, without adding any change to the user device 30 even in the wireless LAN using the IEEE802.1X. Moreover, by using the present invention, it is also made possible to distinguish a connection trouble caused by a malfunction on a wireless network side from a connection trouble caused by a mistake in setting of a user device when solving operational instructions are to be provided.

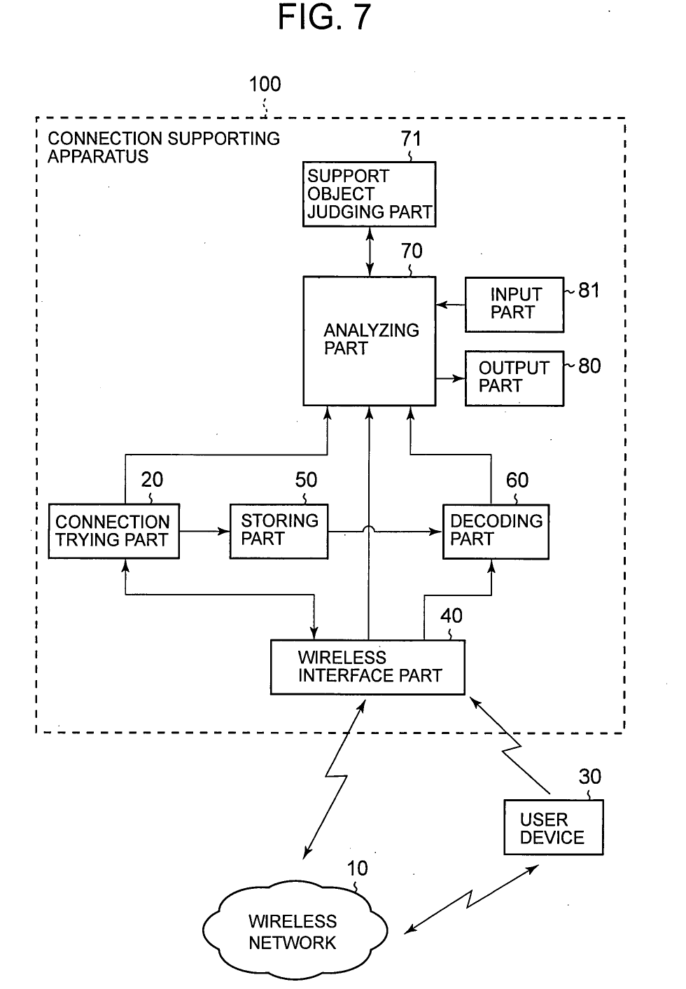

As the second embodiment of the present invention, a method is provided in which, when a plurality of wireless devices exists, a user device requiring connection support is specified to provide connection support. FIG. 7 is a diagram showing configurations of a system of the second embodiment and same reference numbers are assigned to corresponding components shown in FIG. 1. As shown in FIG. 7, the system of the second embodiment includes, in addition to components shown in FIG. 1, a support object judging part 71 to judge and determine a user device, out of a plurality of wireless devices, requiring connection support, and an input part 81 to receive an input from a user.

The support object judging part 71 judges to select a user device to be supported by referring to receiving power of wireless packets transmitted from a plurality of wireless devices and to time when the wireless packets were received. The input part 81 receives an input from a user and stores the time when the input was received. This time is used when the support object judging part 71 estimates the time of transmission of wireless packets from the user device.

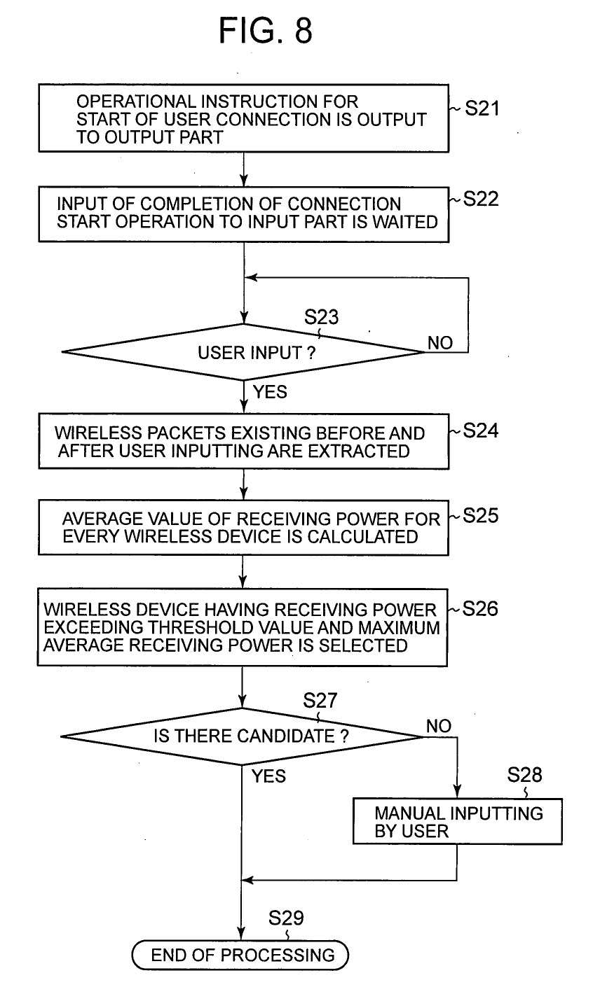

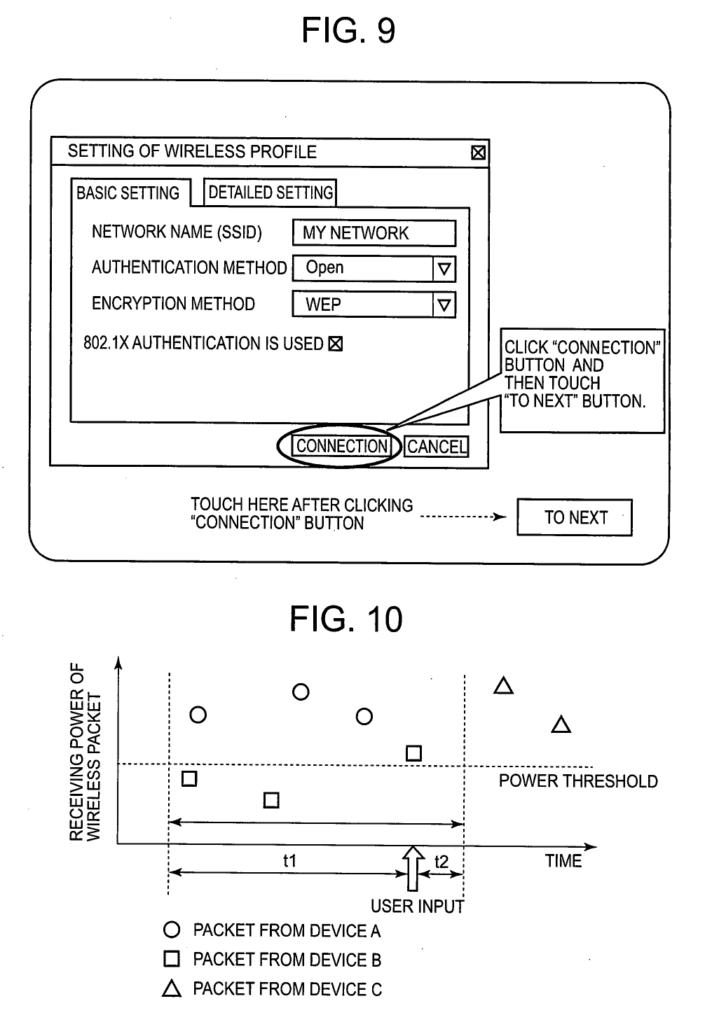

Processes of specifying the user device requiring connection support, which are extracted from processes in the second embodiment, are explained by referring to FIG. 8. The processes may be performed in advance of Step S8 shown in FIG. 3. First, in Step S21, after the completion of connections to a user, the output part 80 instructs the input part 81 to receive an input. An example of the output is a display on the screen as shown in FIG. 9. This is an example of integrated output part 80 and input part 81 (for example, touch panel).

An input from a user is waited for (Step S22) and, when an input arrives, based on the time of the inputting, wireless packets received before and after the inputting are extracted (Step S23). For example, as shown in FIG. 10, if the user inputting occurs at a time t0, only the packets received before and after the inputting are extracted as objects to be analyzed thereafter (Step S24). Preferably, wireless packets to be extracted here are limited to, for example, packets being highly related to connection start such as Authentication packets being subject to the IEEE802.11 standards, Association Request packets, Probe Request packets, or a like.

Then, wireless packets received in Step S24 are sorted according to source addresses and an average value of receiving power for each packet is calculated (Step S25). For example, in FIG. 10, an average value of receiving power for each of packets received from each of devices A, B, and C is calculated. From the calculation, a wireless device having an average value exceeding a predetermined threshold (power threshold in FIG. 10) and being at a maximum value level is judged and selected as a user device to be supported (Step S26).

For example, in FIG. 10, the device B is out of objects since the power average value is below the threshold and the device C is excluded since the packet receiving time is out of objects to be analyzed. Therefore, in this example, the device A is selected since the receiving power average value exceeds the threshold and is at the maximum level. However, there may be a case in which an object to be supported is unable to be determined by the above method due to the reason that an average value of receiving power from all the device is below the threshold. In this case, by outputting a table of addresses of devices having received packets to the output part 80, a user is urged to select a device or a user is urged to directly input so that a device to be supported is judged (Step S28).

The reason why a wireless device having an average value of receiving power exceeding a threshold and having received signals within a specified period of time is selected as a device to be supported is described. The reason why an average value of receiving power has to exceed a threshold is based in a viewpoint that, in ordinary cases, a user having a device to be supported (for example, PC) receives operational support while standing in front of the connection supporting apparatus 100 and seeing a screen and, therefore, it is necessary that a physical distance between the wireless device and the connection supporting apparatus 100 is short and, as a result, the receiving power at the device to be supported is moderately high.

The reason why a wireless device to be supported has to receive signals within a specified period of time is that the device to be supported is selected from a narrower range of objects. That is, in many cases, packets corresponding to the first portion of the connection sequence (particularly, Authentication packet, Authentication Request, or a like) are transmitted with timing when a user manually clicks a connection button and, therefore, by setting the period during which the above packet is monitored after an instruction of “please push the connection button” is displayed by the displaying part to be a period before and after the instruction is provided, the device to be supported can be detected more accurately when compared with the case of using only the receiving power.

Thus, by applying the present invention, it is made possible to provide connection service to a specified user device. Particularly, when a user receives connection support while the user device is placed near the connection supporting apparatus, the apparatus and method are effective.

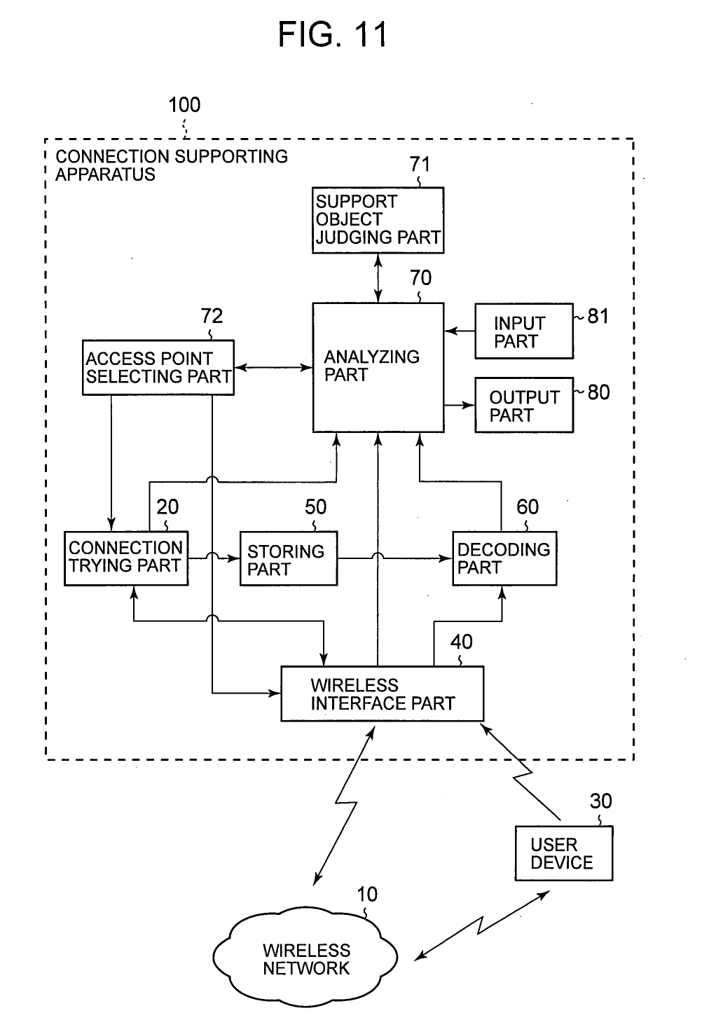

As the third embodiment of the present invention, a connection supporting method is envisioned in which, when a wireless network includes a plurality of wireless LAN access points, an access point to which a user tries to establish connection is selected and determined. Configurations of the system of the third embodiment are shown in FIG. 11 and same reference numbers are assigned to corresponding components as shown in FIGS. 1 and 7.

As shown in FIG. 11, besides components in FIG. 7, an access point selecting part 72 is added. The access point selecting part 72 creates a table of connectable access points using wireless packets received by the wireless interface part 40 and judges an access point to which a user is expected to try the connections and its operating frequency channel and informs the judgment result to the connection trying part 20 and wireless interface part 40.

Here, the frequency channel refers to an identifier representing a carrier frequency of a wireless packet received by an access point and, in ordinary cases, an access point is unable to receive simultaneously wireless packets with a plurality of frequency channels. The frequency channel with which an access point transmits and receives wireless packets at a given point is called an “operating frequency” of the access point. Moreover, in order to receive packets transmitted by the access point operating with a specified frequency channel, it is necessary that the operating frequency of the wireless interface on a receiving side and the operating frequency of the access point are made to coincide with each other.

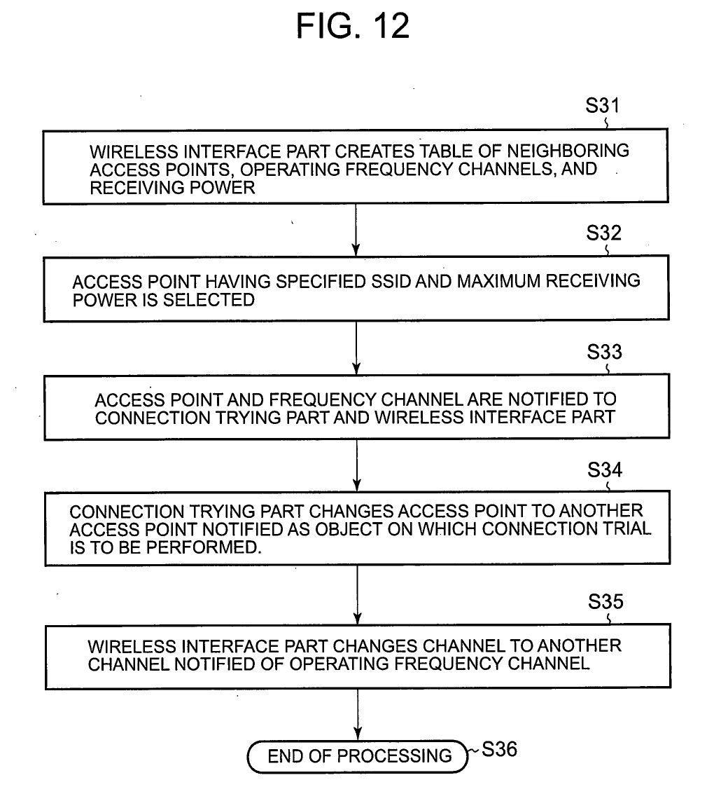

Processes of judging an access point to which a user is expected to try the connections are extracted out of operations in the third embodiment and described by referring to FIG. 12. These processes may be performed in advance of the Step S32 in FIG. 3. First, in Step S31, the wireless interface part 40 creates a table of neighboring access points, operating frequency channels, and receiving power. For this method, active scan and passive scan designated by the IEEE802. 11 standards can be used.

Then, in Step S32, the access point selecting part 72 selects an access point, out of access points listed in the table, having an SSID (Service Set ID) which coincides with the SSID of a wireless network to which connection support is provided and having the maximum receiving power. Then, the access point selecting part 72 notifies the connection trying part 20 and the wireless interface part 40 of the result from the selection (Step S33). The connection trying part 20 having received the notification changes an access point to which trial connections are to be executed to the newly selected access point (Step S34). Also, the wireless interface part 40 having received the notification makes the operating frequency channel to coincide with the operating frequency channel of the selected access point (Step S34).

Thus, by applying the present invention, even when the wireless network includes a plurality of the wireless LAN access points, the access point to which a user is expected to execute trial connections can be judged to provide connection support. Particularly, the third embodiment is effective when a user receives support while the user device is placed in the vicinity to the connection trying apparatus 100.

As the fourth embodiment of the present invention, a connection supporting system is provided in which, when the analyzing part determines solving operations, trouble example database storing analysis results and operations to solve faults is referred to and the above trouble example database is placed far apart and a plurality of connection supporting apparatus is connected thereto.

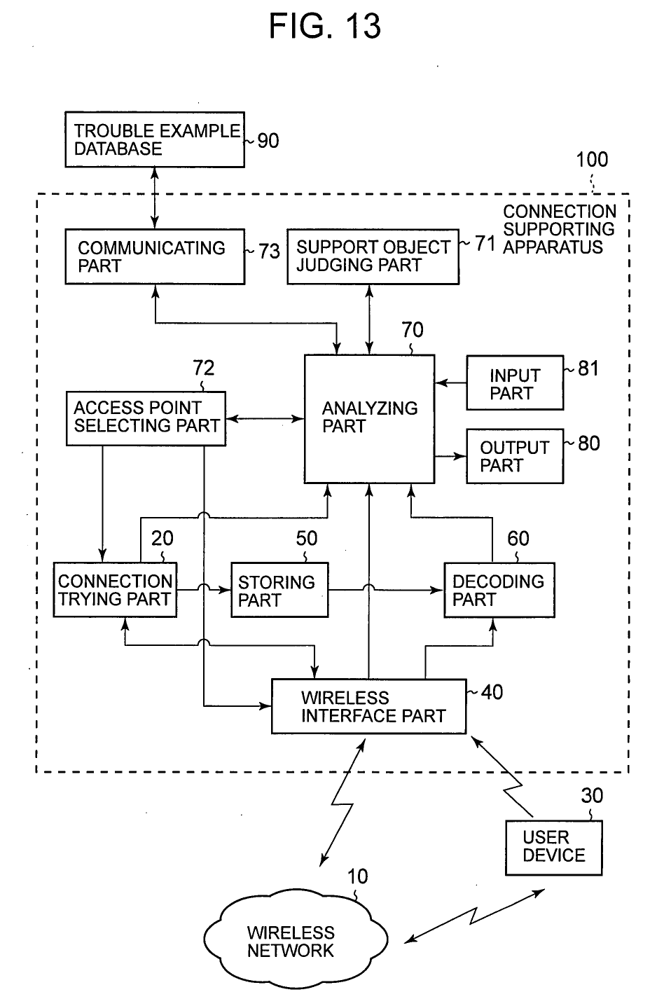

Rough configurations of the connection supporting system and components of the connection supporting apparatus used in the system are shown in FIG. 13 and same reference numbers are assigned to corresponding components as shown in FIG. 11. Besides components included in the system shown in FIG. 11, a trouble example database 90 to store analysis results is added thereto. In this case, the trouble example database 90 is installed separately from the connection support apparatus 100 and both are connected via the network.

As shown in FIG. 13, the connection supporting apparatus 100 includes additionally a communicating part 73 to receive solving operations corresponding to the analysis results from the trouble example database 90. Moreover, the connection supporting system may be configured to include a plurality of connection supporting apparatuses 100 shown in FIG. 13 each of which is connected to the trouble example database 90 via the network.

The communicating part 73 has a function of making an inquiry of the trouble example database 90 about solving operations corresponding to analysis results. Generally, such an inquiry may be made via the network 11 or a like and such a network may includes the wireless network to be supported. That is, an inquiry may be transferred by wireless packets transmitted from the wireless interface part 40.

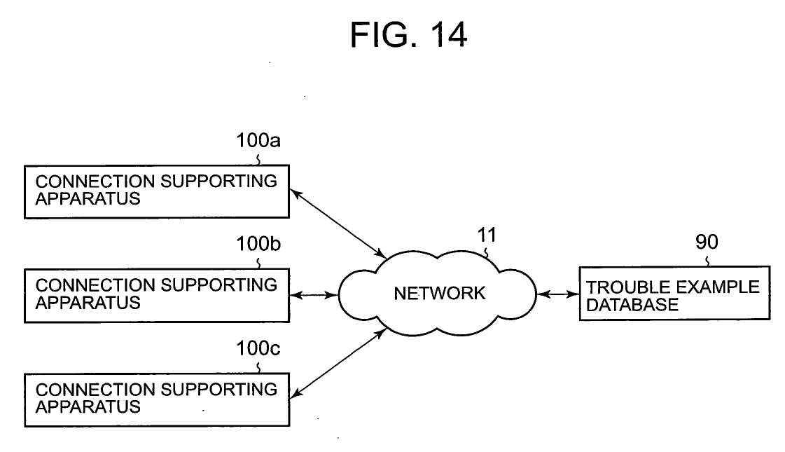

The trouble example database 90 stores analysis results listed in FIG. 5 and information about solving operations and makes a response of corresponding operation methods according to analysis results transmitted from the communicating part 73 of the connection supporting apparatus 100. Moreover, as shown in FIG. 14, a single trouble example database 90 may be connected to a plurality of connection supporting apparatuses 100a to 100b via the network 11 and a plurality of inquires can be processed, at the same time, for making a response.

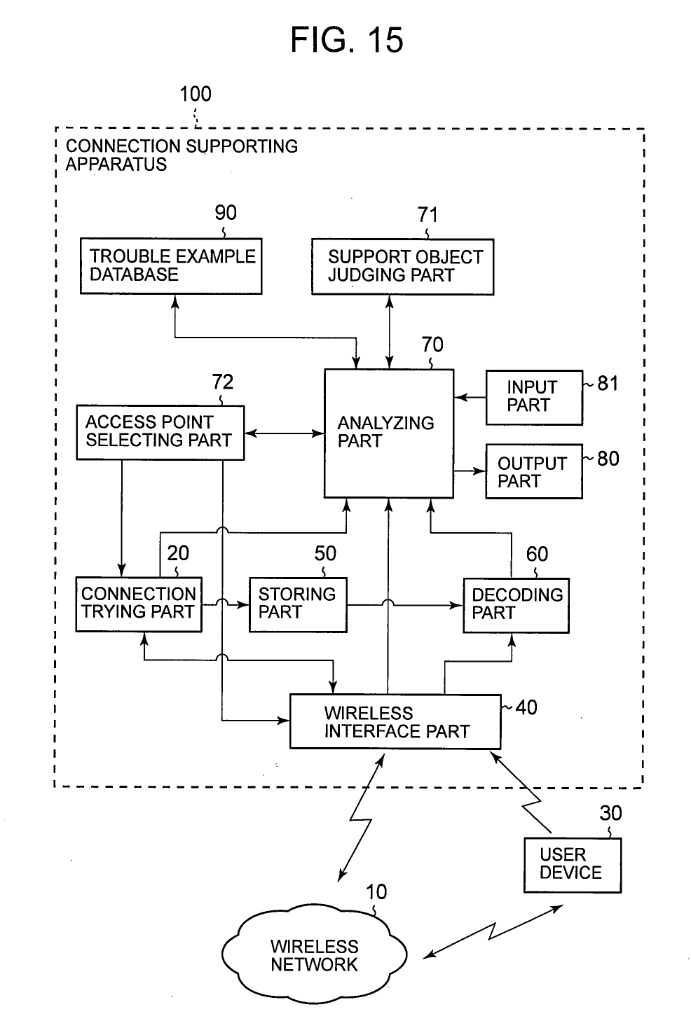

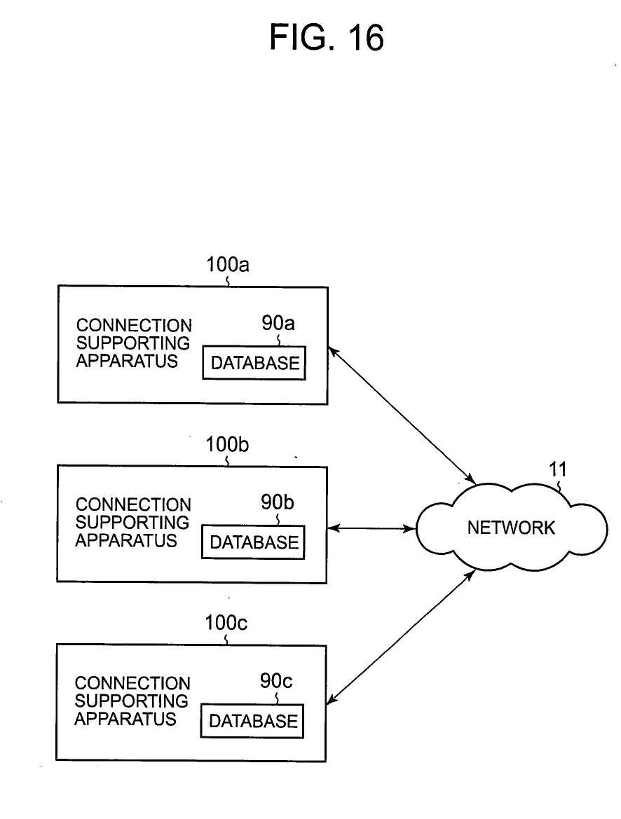

As shown in FIG. 15, the trouble example database 90 may be installed in the connection supporting apparatus 100. In this case, communications between the trouble example database 90 and the apparatus 100 are not needed and, therefore, the communicating part 73 shown in FIG. 13 is not required. Moreover, as shown in FIG. 16, each of the trouble example databases 90a to 90c may be installed in each of the connection supporting apparatuses 100a to 100c and, by connecting each of the trouble example databases 90a to 90c with each of the connection supporting apparatuses 100a to 100c via the network 11 to allow communications to be carried out among databases 90a to 90c, the trouble example databases 90a to 90c may be used as a distributed database in which each data can be referred to one another.

Thus, by applying the present invention, even when a plurality of connection supporting apparatuses exist, it is made to renew operation methods corresponding to analysis results. Also, by unifying an information exchange interface between the connection supporting apparatus and the trouble example database, it is made for a owner having a trouble example database to provide connection fault diagnosis service to a plurality of different wireless network providers that possess or rent the connection supporting apparatus.

As the fifth embodiment of the present invention, a method is provided in which, when a user makes an inquiry of an attended user support center by using a telephone, a communicating part transmits analysis results to a local condition information receiving device to be installed in the user support center. This situation occurs in the case when solving operations cannot be automatically provided to a user by the methods already disclosed in the present invention. For example, in the state 7 in FIG. 5, after making a user confirm and check a routing table, an instruction for making an inquiry of the attended user support center is output on a screen.

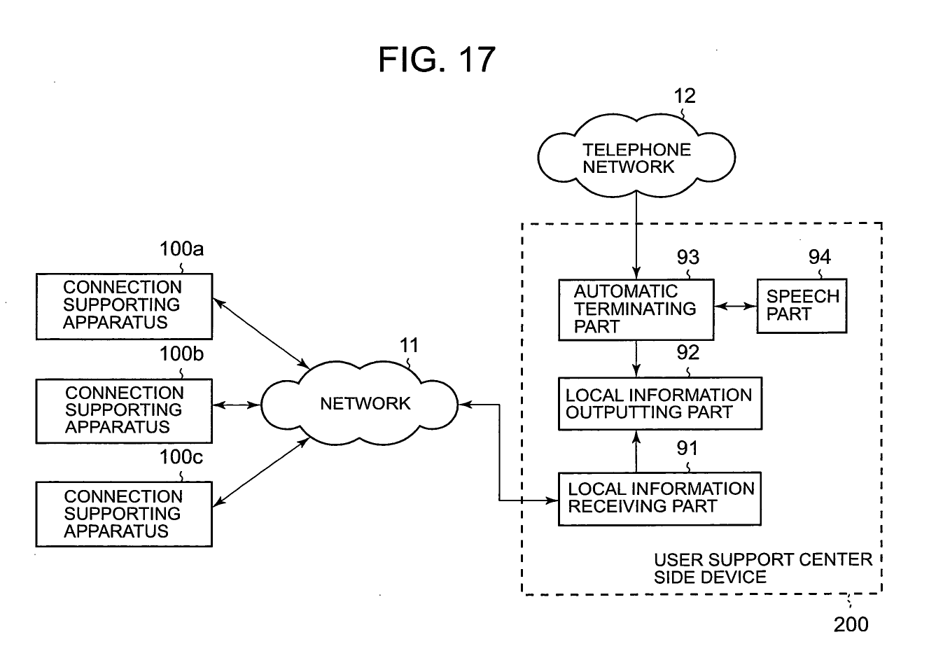

In the above connection supporting system, as shown in FIG. 17, a means for determining an identifier to be associated with an analysis result transmitted by a communicating part is installed in each analyzing part of the connection supporting apparatuses 100a to 100c and a user support center side device 200 connected via the network 11 is mounted. The user support center side device 200 includes a local information receiving part 91 to receive an analysis result associated with an identifier, a local information outputting part 92 to provide an analysis result received by the information receiving part 91 to a user support staff, an automatic terminating part 93 to automatically process an incoming signal from a telephone network and to transfer the processed signal to the user support staff, and a speech part 94 to allow a user support staff to make a speech with a user.

The analyzing part of the connection supporting apparatus associates an identifier with an analysis result. Only the identifier can identify an analysis result and may be automatically created on the connection support device side according to date and time and/or device number of the connection supporting device or may be acquired from the local information receiving part 91 when the analyzing part transmits an analysis result. The analyzing part outputs the identifier including an instruction for making an inquiry of the attended user support center side device 200 to the output part.

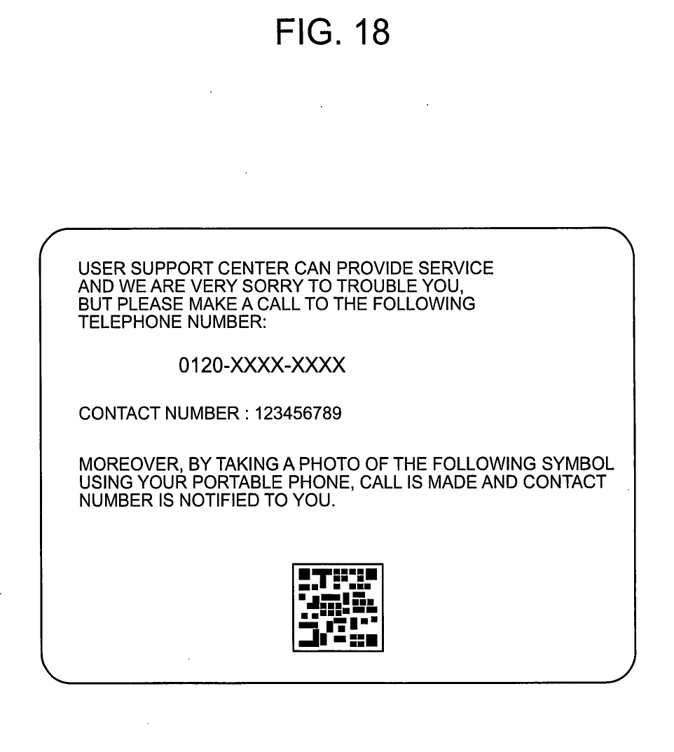

This output may be made up of a character string consisting of an alphabet and a numeral and may be read out by a user to a user support staff. As shown in FIG. 18, the output may be displayed as a symbol such as a two-dimensional barcode containing information providing a contact such as a telephone number of the user support center side device 200 and a user may call by reading a symbol using a two-dimensional barcode reader of a portable phone to make the output automatically be transferred to the user support staff. Moreover, in FIG. 18, the number “0120-XXX-XXXX” is a telephone number of the user support center and the number “123456789” being a contact number is an identification number associated with the analysis result described above.

The local information receiving part 91 of the user support center side device 200 stores analysis results transmitted from the communicating part associated with an identifier. Then, the local information receiving part 91 provides the analysis results in response to a request from the local information outputting part 92. At this time point, in order to specify required analysis results, information about an identifier is used. The local information outputting part 92 transmits a request for analysis results containing an identifier to the local information receiving part 91 and then the local information outputting part 92 obtains the analysis results and displays the analysis results in a manner in which a user support staff can make a reference thereto. Here, the identifier to be provided to the local information receiving part 91 may be input by the user support staff to the local information outputting part 92 or may be acquired automatically from the automatic terminating part 93.

Moreover, a plurality of the local information outputting part 92 may be installed so that a plurality of user support staffs can utilize. The automatic terminating part 93 waits for a coming call from the telephone network 12 and, when the incoming call arrives, processes information notified at a time of the arrival of the incoming call to extract an identifier and further forwards the speech to the speech part 94. Further, the automatic terminating part 93 transfers the extracted identifier to the local information outputting part 92. Moreover, a plurality of speech parts 93 may be installed so that a plurality of user support staffs can use. In this case, preferably, the local information outputting part 92, to which an identifier is transferred, corresponding to the speech part 94 which processes transferred speech is automatically selected.

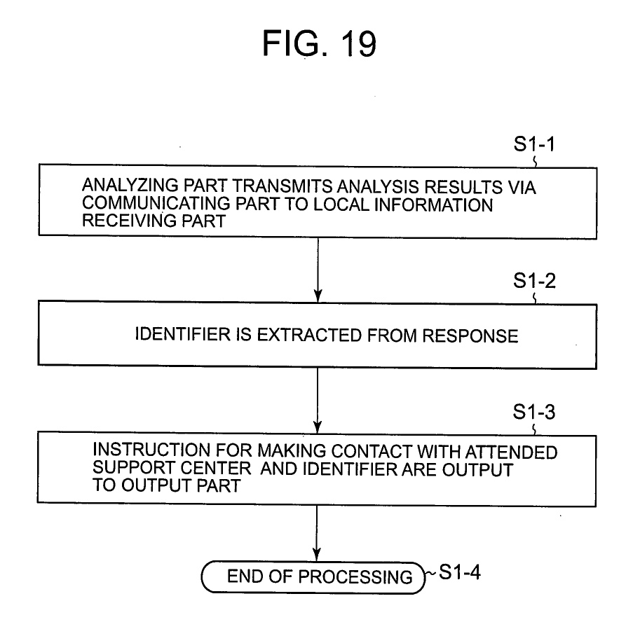

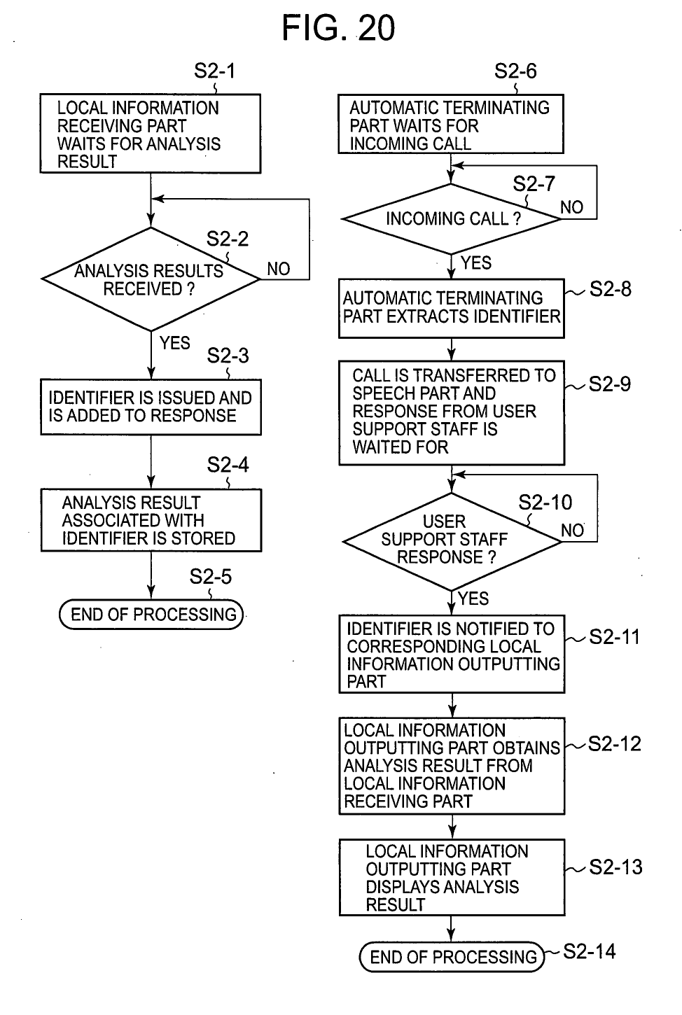

Then, processes of displaying an instruction to make a user call the attended user support center and of responding to a call from a user extracted from operations in the fifth embodiments are explained by referring to FIGS. 19 and 20. FIG. 19 shows operations of the connection supporting apparatus 100. FIG. 20 shows operations of the user support center side device 200. The processing shown in FIG. 19 is a concrete example of operational instructions described in Step S16 in FIG. 3.

First, if it is judged from the analysis of wireless packets by the analyzing part that the attended user support is required, the analyzing part transmits the analysis results via the communicating part to the local information receiving part 91 (Step S1-1). On the other hand, the local information receiving part 91 ordinarily waits for the transmission of analysis results (Step S2-1) and, when receiving the analysis results, issues an identifier, makes the identifier be contained in a response to the transmission of the analysis results to distribute the information to the connection supporting part (Step S2-3) and stores the information with the received analysis results being associated with the issued identifier (Step S2-4)

On the other hand, the connection supporting apparatus 100 having received the identifier displays an instruction for contacting with the attended support center and identifier on the output part (Step S1-3). When a user receiving the instruction makes a call to the user support center, the automatic terminating part 93 monitoring an incoming call makes a response (Step S2-6) and, after extracting an identifier contained in the call information (Step S2-8), forwards the call to the speech part 94 of the user support staff and waits for the response (S2-9). When the user support staff takes the call, the automatic terminating part 93 transmits the identifier to the local information outputting part 92 of the user support staff (Step S2-11). The local information outputting part 92 having received the identifier acquires, using the identifier, the analysis results from the local information receiving part 91 (Step S2-12). The acquired analysis results are output on a screen of the local information outputting part 92 (Step S2-13) and are utilized by the user support staff.

Thus, by applying the present invention, even when connection troubles cannot be solved singly by the connection supporting apparatus and solving operational instruction by an attended user support center is required, it is made possible to immediately notify of a user support staff about local situations, thereby making the support effective and enabling the reduction of support costs. Also, by using the present invention, it is made for a owner having the user support service to provide a connection support service to a plurality of different wireless network providers that possess or rent the connection supporting apparatus.

An example of the application of the present invention includes a connection supporting apparatus to be used for public wireless LAN connection service, that is, for hot spot service. When hot spot service is provided, for example, in a lobby of a hotel, by placing the connection support apparatus in a corner of the service area, connection support can be provided, in behalf of an employee of the hotel, to a user who is not successfully executing connection to a wireless LAN.

In this situation, an employee may introduce the connection supporting apparatus of the present invention after having received an inquiry about connections, however, by connecting a communicating part of the connection supporting apparatus of the present invention to an apparatus placed on a front desk in a hotel and by configuring the connection supporting apparatus so as to raise an alarm when the existence of a device having failed in connections to a network is detected, more active service can be provided without the need of waiting for an inquiry from a user by detecting a user who is not successfully establishing connections.

Furthermore, an example of the method of detecting a device having failed in the connection in the above case is described. By monitoring all packets all the time without specifying any device to be supported and by detecting a device for which all sequences shown in FIG. 4 have not been completed, the detection of the device having failed in the connection is enabled. In this case, which device (of a customer of a hotel) has failed in the connection is not known, however, a front staff can recognize that there is a person being at least in trouble and, therefore, can look around to make a contact.

An example of the application of the present invention includes a use as a tool to respond to connection troubles in an internal network for an information division of an enterprise. When a staff of the information division is contacted by a user about the connection troubles, by bringing the connection supporting apparatus to a site, connection troubles can be solved in a shorter time of period.

It is clear that operations in each of the above embodiments can be stored in advance as program in a storing medium such as a ROM (Read Only Memory) and the program can be read out by a computer to be executed.

1-56. (canceled)

57. A connection support apparatus for providing a wireless communicating terminal with support for connections to a wireless network comprising:
a connection trying means to execute a trial connection to said wireless network by using a test account being able to provide a correct connection while said wireless network is operating normally;
an analyzing means to analyze trial results from said trial connections; and
an outputting means to output a solving operational instruction corresponding to an analysis result provided by said analyzing means;
a receiving means to receive all wireless packets being receivable from a wireless medium; and
a decrypting means to decrypt packets when said packets received from said receiving means have been encrypted;
wherein said decrypting means, when said connection trying means succeeds in said trial connections, decrypts encrypted packets by using a key received from said receiving means.

58. The connection support apparatus according to claim 57, wherein said key is a broadcast key and packets, out of said encrypted packets, to be decrypted by said decrypting means are broadcast packets.

59. The connection supporting apparatus according to claim 57, further comprising a support object judging means to specify a connection support object terminal out of a plurality of wireless communicating terminals and an inputting means to accept an input from a user, wherein said support object judging means specifies said connection support object terminal based on receiving power of a packet received within a predetermined time of period before and after a time of a user input.

60. A connection support method for providing a wireless communicating terminal with support for connections to a wireless network comprising:
a connection trying step of executing a trial connection to said wireless network by using a test account being able to provide a correct connection while said wireless network is operating normally;
an analyzing step of analyzing trial results obtained from said trial connection; and
an outputting step of outputting a solving operational instruction corresponding to an analysis result provided by said analyzing means;
a receiving step of receiving all wireless packets being receivable from a wireless medium; and
a decrypting step of decrypting packets when said packets received by said receiving step have been encrypted;
wherein, in said decrypting step, if said trial connection results in a success, encrypted packets are decrypted by using a key received in said receiving step.

61. The connection supporting method according to claim 60, wherein said key is a broadcast key and packets, out of said encrypted packets, to be decrypted by said decrypting means are broadcast packets.

62. The connection supporting method according to claim 60, further comprising a support object judging step of specifying a connection support object terminal out of a plurality of wireless communicating terminals and an inputting step of accepting an input from a user, wherein, in said support object judging step, said connection support object terminal is specified based on receiving power of a packet received within a predetermined time of period before and after a time of a user input.

63. A program of making a computer execute operations of a wireless network connection supporting method to provide a wireless communicating terminal with support for connections to a wireless network comprising:
a connection trying processing of executing a trial connection to said wireless network by using a test account being able to provide a correct connection while said wireless network is operating normally;
an analyzing processing of analyzing trial results from said trial connection; and
an outputting processing of outputting a solving operational instruction corresponding to an analysis result provided by said analyzing processing;
a receiving processing of receiving all wireless packets being receivable from a wireless medium; and
a decrypting processing of decrypting packets when said packets received by said receiving step have been encrypted;
wherein, in said decrypting processing, when said trial connection results in a success, encrypted packets are decrypted by using a key received by said receiving processing.

64. The program according to claim 63, wherein said key is a broadcast key and packets, out of said encrypted packets, to be decrypted by said decrypting processing are broadcast packets.

65. The program according to claim 63, still comprising support object judging processing of specifying a connection support object terminal out of a plurality of wireless communicating terminals and inputting processing of accepting an input from a user, wherein, in said support object judging processing, said connection support object terminal is specified based on receiving power of a packet received within a predetermined time of period before and after a time of a user input.
